(19) United States
(12) Patent Application Publication
(10) Pub. No.: US 2006/0294208 A1
(43) Pub. Date: Dec. 28, 2006

(54) Methods and apparatus for subscriber configuration of cooperative communication services

(76) Inventors: Thomas Lee Adams, Austin, TX (US); David Pennington Dudley, Meadow Vista, CA (US); Sharmila Dilip Patel, Pleasanton, CA (US)

Correspondence Address: HANLEY, FLIGHT & ZIMMERMAN, LLC, 20 N. WACKER DRIVE, SUITE 4220, CHICAGO, IL, 60606, US

(21) Appl. No.: 11/166,576

(22) Filed: Jun. 24, 2005

(51) Int. Cl. G06F 15/177

(52) U.S. Cl. 709/220

(57) ABSTRACT

Methods and apparatus for subscriber configuration of cooperative communication services are disclosed. A disclosed example system comprises a first communication system to provide a Unified Communications service to a customer, a second communication system to provide a telephony service to the customer, a communications path between the first and the second communication systems configurable to exchange communication service data, and a configuration server to provide a user interface to receive a service configuration from the subscriber, and to configure the first and the second communication systems to deliver a service associating the Unified Communications service with the telephony service using at least one resource from each of the first and the second communication systems.

### FIELD OF THE DISCLOSURE

This disclosure relates generally to communication services and systems, and, more particularly, to methods and apparatus for subscriber configuration of cooperative communication services.

### BACKGROUND

Increasingly, providers of communication services (i.e., service providers) desire to create and offer cooperative (i.e., combined or converged) communication services. An example customer subscribes to a voicemail service provided by a first service provider (e.g., SBC Communications Inc.), and to a wireless telephony service provided by a second service provider (e.g., Cingular). In an example, the first and the second service providers, through acquisition, agreement, etc., desire to provide a Cooperative Communication Service (CCS) capable to associate voicemail accounts provided by the first service provider with wireless telephony accounts provided by the second service provider. In particular, an unanswered incoming telephony call (e.g., busy, unavailable, etc.) routed to the wireless telephony service subscribed to by the example customer is automatically re-routed to the voicemail service subscribed to by the example customer. As a result of the example CCS, the example customer experiences a convergence of their communication services into a single location.

FIG. 1 illustrates an example prior-art system capable to provide CCSs. In the example of FIG. 1, a communication service subscriber (i.e., subscriber, customer, or user) 105 subscribes to a first communication service (i.e., service) 107A (e.g., plain old telephone service, voicemail, etc.) provided by a first communication system (i.e., system) 110A operated by a first service provider (i.e., provider) (e.g., SBC Communications Inc.), and a second service 107B (e.g., wireless telephony service) provided by a second system 110B operated by a second provider (e.g., Cingular).

In the illustrated example of FIG. 1, the systems 110A and 110B communicate using, among other things, a communications path (i.e., path) 112 that allows the systems 110A and 110B to exchange data associated with communications services (e.g., signals or data representative of speech, facsimile, video, audio, computer communications, etc.). For example, the path 112 allows a customer (e.g., user 105) of the system 110A to place a telephony call to a customer of the system 110B. The path 112 can be constructed using one or more of a variety of well known technologies (e.g., an Internet Protocol (IP) based network, an Asynchronous Transfer Mode (ATM) based network, a Frame Relay based network, a Public Switched Telephone Network (PSTN), and/or a general purpose telephony network).

To provide communications between customers of the system 110A, and with customers of other systems, the system 110A includes a communication network (i.e., network) 115A. The network 115A can be constructed using one or more of a variety of well known techniques (e.g., CLASS 5 central office switch(es), ATM switch(es), communication path(s), etc.). To configure and maintain the network 115A, the example system 110A includes a well known Operational Support System (OSS) 120A. The OSS 120A allows, among other things, the provider to configure services, provision services, maintain services, bill customers for services, etc. Similarly, the system 101B includes a network 115B and an OSS 120B. The implementation, architecture, details, etc. of the network 115B and OSS 120B could be different from network 115B and OSS 120A.

It will readily apparent to persons of ordinary skill in the art that systems 110A and 110B can be configured to provide a CCS. For example, the system 110B can be configured to forward an unanswered telephony call to a communication service (e.g., a voicemail account, a telephone number, etc.) provided by the system 110A. In an example, to facilitate the configuration of a CCS, the systems 110A and 110B can be connected together with additional communication paths 130 and 135, and a communication bridge (i.e., middleware) 140. The paths 130 and 135 and the bridge 140 allow the OSSs 120A and 120B to communicate. For example, the OSS 120A could send configuration information specifying a CCS to the OSS 120B. In particular, the OSS 120A could indicate (i.e., send) to the OSS 120B voicemail account information (e.g., a forwarding telephone number for the voice mail account), and a telephone number provided by the system 110B. In response, the OSS 120B configures the network 115B to forward unanswered calls to the indicated telephone number to the indicated voicemail account (i.e., associates the telephone number with the voicemail account) across the communication path 112.

Since the OSSs 120A and 120B may be implemented using software provided by different software vendors and utilize incompatible communication protocols, data storage, etc., the bridge 140 of FIG. 1 provides message and protocol translations. For example, OSS 110A could utilize Message Queuing (MQ) based communications, while OSS 110B could utilize Simple Object Access Protocol (SOAP) or an eXchange Markup Language (XML) based protocol. Implementations of the bridge (i.e., middleware) 140, and message and protocol translations are well known to persons of ordinary skill in the art, and, thus, will not be discussed further.

In the illustrated example of FIG. 1, to configure a CCS the subscriber 105 contacts a customer service representative 145 of the system 110A. The subscriber 105 provides any necessary information to the representative 145 who then configures (by interacting with the OSS 120A) the requested CCS. For example, the representative 145 enters configuration information into the OSS 120A using, for example, a computer terminal. The OSS 120A validates the configuration information. If the information is validated, the OSS 120A configures the network 115A, and sends appropriate configuration information to the system 110B via the paths 130 and 135 and the bridge 140. The OSS 120B receives and validates the received configuration information. If the information is validated, the OSS 120B configures the network 115B. Finally, the OSS 120B sends a response to the system 110A indicating success or failure. The representative 145 receives from the OSS 120A the indication of success or failure for the configuration, and passes the same along to the user 105. If the configuration is unsuccessful, the representative 145 can correct the entered information, or obtain additional information from the user 105 and re-submit the configuration request.

### BRIEF DESCRIPTION OF THE DRAWINGS

FIG. 1 is a schematic illustration of an example prior-art system to provide cooperative communication services.

FIG. 2 is a schematic illustration of an example system for Internet based subscriber configuration of cooperative communication services constructed in accordance with the teachings of the invention.

FIGS. 3-5 are example message exchanges which may be executed to implement the example system of FIG. 2.

FIG. 6 is a flowchart representative of example machine readable instructions which may be executed to implement the configuration server of FIG. 2.

FIG. 7 is a schematic illustration of an example processor platform that may execute the example machine readable instructions represented by FIG. 6 to implement the configuration server of FIG. 2.

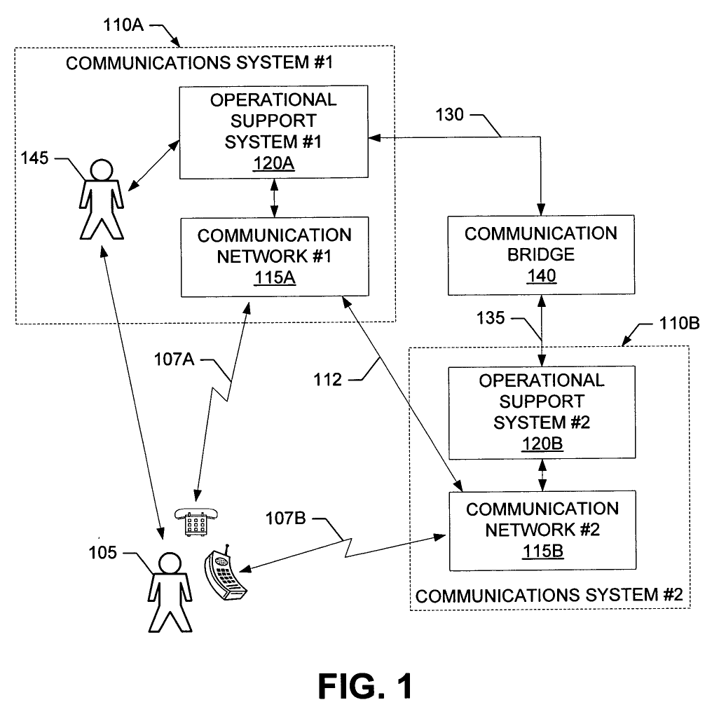

### DETAILED DESCRIPTION

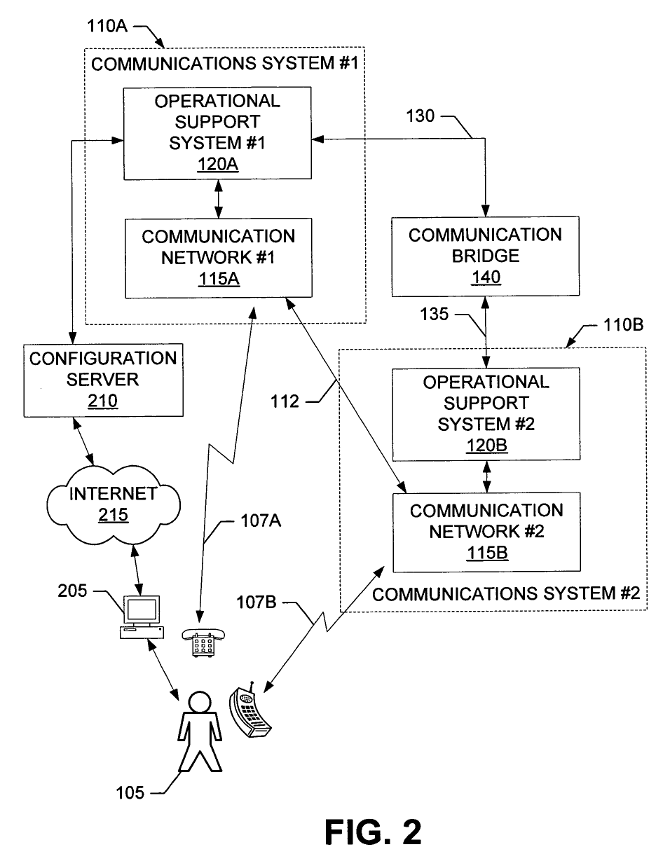

FIG. 2 illustrates an example system constructed in accordance with the teachings of the invention for Internet based subscriber configuration of cooperative communication services. To allow the user 105 to configure a CCS, the example system of FIG. 2 includes an interface device 205 and a configuration server 210. To connect the interface device 205 and the configuration server 210, the illustrated example of FIG. 2 includes a well-known Internet based connection 215 between the interface device 205 and the configuration server 210. It will be readily apparent that the interface device 205 can be implemented using any one of a variety of well known devices. For example, a Personal Computer (PC), a Personal Digital Assistant (PDA), a cell phone, etc. capable to connect to the Internet 215 and display a web based user interface.

The configuration server 210 of the illustrated example of FIG. 2 provides a web based user interface to the interface device 205 via the Internet 215. The configuration server 210 also interacts with the system 110A and/or the system 110B to configure a CCS requested by the user 105 via the user interface. The configuration server 210 provides a web based interface that presents to the user 105, among other things, an option to initiate a CCS configuration. In an example, a web based interface contains a button or other element on the web based display entitled “My Landline and Wireless Phone Numbers and Greetings.” In response to selection of the button or element (using standard web based interface usage techniques), the configuration server 210 presents one or more additional web based interfaces that prompt for wireless phone number(s), identifying information associated with the wireless phone number(s), status screens, error message displays, information displays, etc. In response to the additional information provided by the user 105 in response to the additional web based interfaces, the configuration server 210 interacts with the system 110A and/or the system 110B to associate a wireless phone number with a SBC Unified Communications^{SM} account (i.e., configures the system 110B to forward unanswered calls placed to the wireless phone number to the Unified Communications account).

It will be readily apparent to persons of ordinary skill in the art that the user 105 and the configuration server 210 could configure additional types of CCSs. For example, the user 105 and the configuration server 210 could interact to configure a CCS that forwards a call placed to phone number (e.g., wireless, VoIP, land line, etc.) provided by the system 110B with a telephone number (e.g., wireless, VoIP, land line, etc.) provided by the system 110A. In another example, the user 105 and the configuration server 210 could interact to configure a CCS that forwards caller identification (i.e., caller ID) information provided by the system 110B to a communication service provided by the system 110A. In yet another example, a CCS could be configured by the user 105 and the configuration server 210 to forward a call placed to a telephone number provided by the system 110B to a facsimile service or a voicemail service provided by the system 110A.

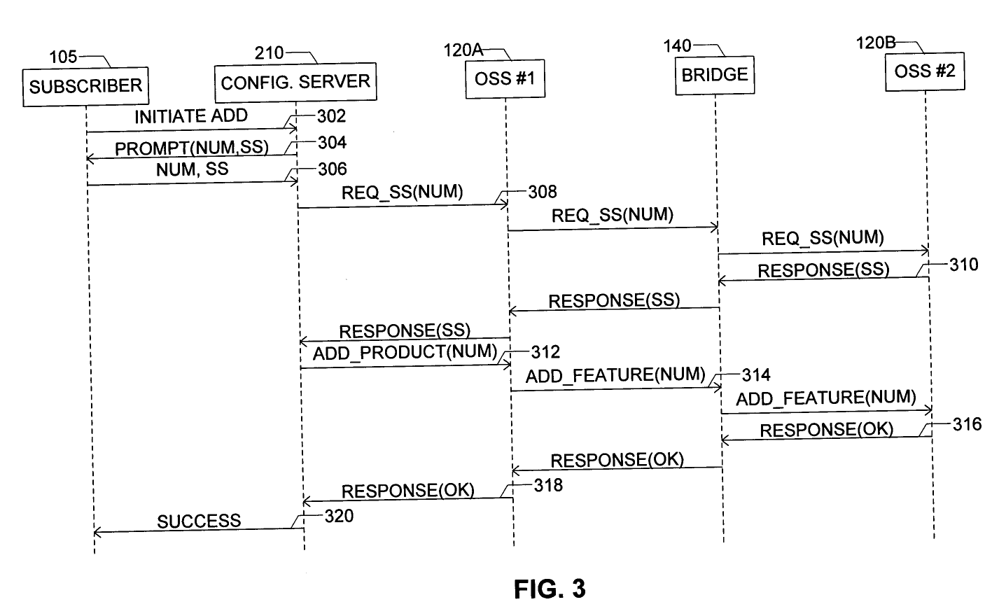

FIG. 3 illustrates an example message exchange, that associates a telephone phone number (e.g., wireless, VoIP, PSTN, etc.) provided by the system 110B with a Unified Communications account provided by the system 110A, which may be executed to implement the example system of FIG. 2. The example exchange of FIG. 3 begins with the subscriber 105 initiating, via a web based interface provided by the configuration server 210, a CCS configuration request 302 to add a telephone phone number provided by the system 110B to their Unified Communications account. In response to the CCS configuration request 302, the configuration server 210 provides another web based interface 304, via the interface device 205 and the Internet 210, prompting the subscriber 105 to enter the phone number and a password (e.g., the last four digits of a social security (SS) number or a business tax identification (ID) number) associated with the phone number. In response to the prompt, the subscriber 105 enters the requested information and selects a button provided by the web based interface to send a response 306 containing the entered information to the configuration server 210.

The configuration server 210 sends a request 308 to the OSS 120B to obtain the password (e.g., the last four digits of a SS number or a business tax ID number) associated with the entered phone number. As illustrated in the example of FIG. 3 the request 308 is sent to the OSS 120B via the OSS 120A, the path 130, the bridge 140, and the path 135 using well-known techniques. In response to the request 308, the OSS 120B sends a response 310 back to the configuration server 210 (along the same path used by the request 308) containing the password associated with the provided phone number.

The configuration server 210 compares the password received from the OSS 120B to the password received from the subscriber 105. If the passwords match, the configuration server 210 sends a message 312 to the OSS 120A requesting that the phone number be added to the Unified Communications account. In response to the message 312, the OSS 120A configures the network 115A, and sends a message 314 to the OSS 120B containing the phone number and a forwarding phone number to which unanswered calls to the phone number should be forwarded. In response to the message 314, the OSS 120B configures the network 115B, and sends a message 316 to the OSS 120A indicating success or failure of the configuration. When the OSS 120A receives a success response message 316 from OSS 120B, the OSS 120A provides a message 318 indicating configuration success to the configuration server 210. The configuration server 210 then provides a configuration successful web based display 320 to the subscriber 105.

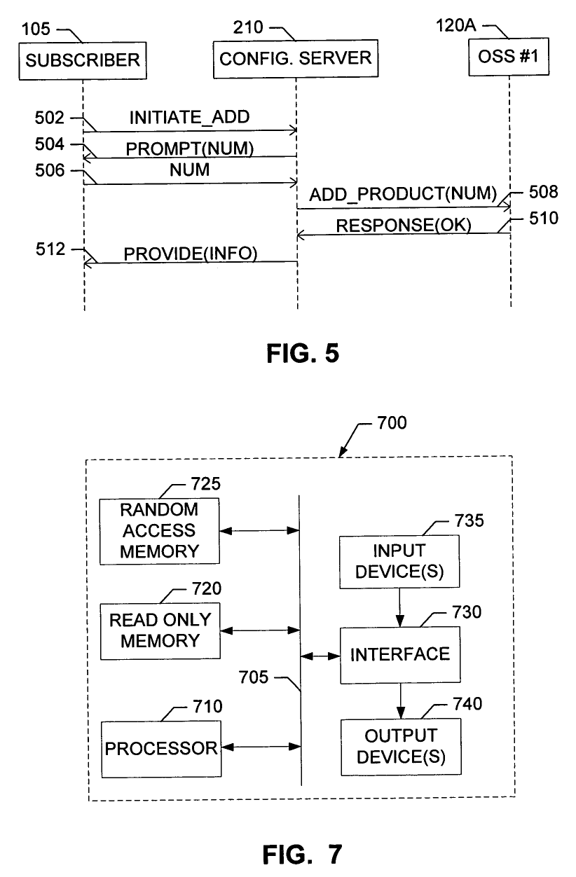

It will be readily apparent to persons of ordinary skill in the art that the example message exchanges illustrated in FIGS. 3 and 5 (discussed below) could be used to remove an association between the phone number and the Unified Communications account. For example, the content and meaning of the messages 302, 312 and 314 could be modified to reflect a removal of association rather than an addition of association. Further, the configuration server 210 could optionally skip the authentication of password (i.e., messages 304, 306, and 310).

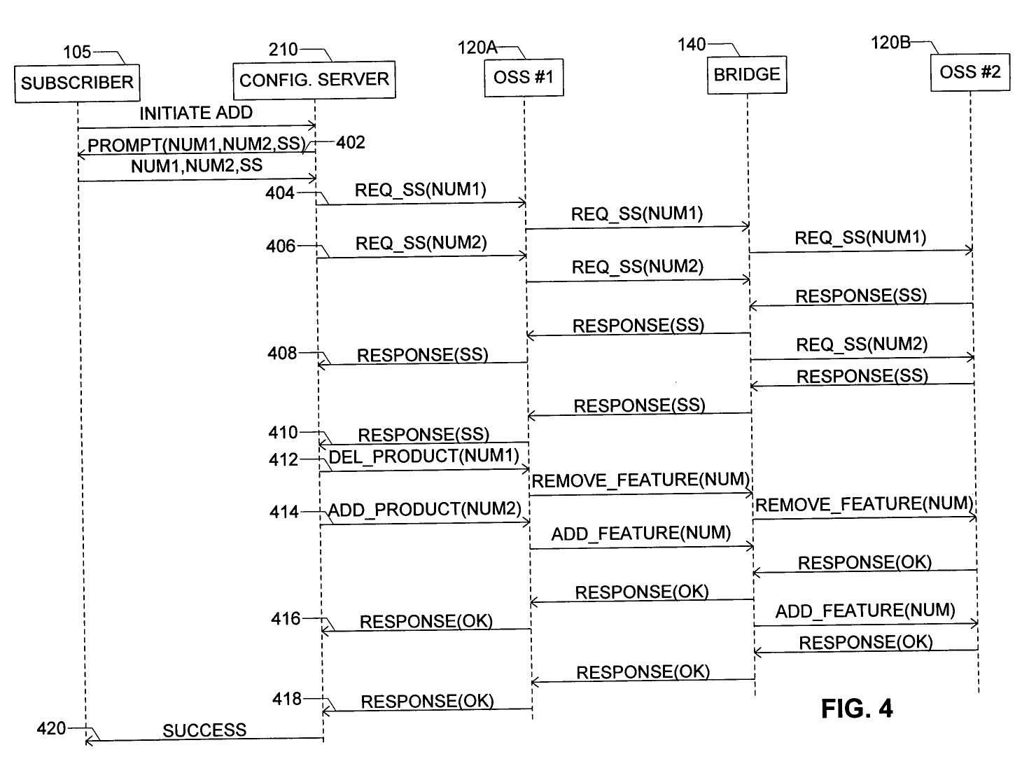

FIG. 4 illustrates an example message exchange, that replaces a first phone number (e.g., wireless, VoIP, PSTN, etc.) that is currently associated with a voicemail account with a second phone number, which may be executed to implement the example system of FIG. 2. The first and the second telephony services are not restricted to be the same type of telephony service (e.g., wireless, VoIP, PSTN, etc.). The example exchange of FIG. 4 is executed in a fashion similar to the example exchange of FIG. 3. Compared to FIG. 3, in the example exchange of FIG. 4, the configuration server 210 prompts via a web based display 402 the subscriber 105 to enter two phone numbers. Further, the configuration server 210: a) obtains from the OSS 120B the password (e.g., last four digits of a SS number or a business tax ID number) associated with each phone number using two messages 404 and 406; b) receives back two messages 408 and 410 containing the requested passwords; and c) verifies the subscriber 105 is authorized to modify accounts associated with each phone number. The configuration server 210 then initiates two separate CCS configurations via two messages 412 and 414 that deletes (i.e., removes) the existing association between the first phone number and the voicemail account, and adds a new association between the second phone number and the voicemail account, respectively. Finally, the configuration server 210 waits for two successful CCS configuration response messages 416 and 418 before notifying the customer with a success message 420.

FIG. 5 illustrates an example message exchange, that associates a telephone phone number (e.g., wireless, VoIP, PSTN, etc.) provided by a system 110B (that cannot communicate with the system 110A via the path 130, the bridge 140 and the path 135) with a facsimile account provided by the system 110A, which may be executed to implement the example system of FIG. 2. The example exchange of FIG. 5 begins with the subscriber 105 initiating, via a web based interface provided by the configuration server 210, a CCS configuration request 502 to add a telephone phone number provided by the system 110B to their facsimile account. In response to the CCS configuration request 502, the configuration server 210 provides another web based interface 504 prompting the subscriber 105 to enter the phone number. In response to the prompt, the subscriber 105 enters the requested information and selects a button provided by the web based interface to send a response 506 containing the entered information to the configuration server 210.

The configuration server 210 sends a message 508 to the OSS 120A requesting that the phone number be added to the facsimile account. In response to the message 508, the OSS 120A configures the network 115A, and sends a message 510 indicating configuration success and a forwarding telephone number associated to the facsimile account to the configuration server 210. Since the configuration server 210 cannot automatically configure the system 110B, the configuration server 210 provides a configuration successful web based display 512 that provides information informing the subscriber 105 how to configure the system 110B. For example, a customer service phone number for system 110B to call, and the forwarding phone number to which calls to the phone numbers should be forwarded by the network 115B.

It will be readily apparent to persons of ordinary skill in the art that any of a variety of well known actions can be taken in response to any of the various possible error conditions possible in the example message exchanges of FIGS. 3-5. In an example, if the password received from the OSS 120B do not match the password received from the subscriber 105, the configuration server 210 could provide a web based interface that re-prompts the subscriber 105 to re-enter the password (e.g., the last four digits of a SS number or a business tax ID number) associated with a phone number. In another example, the configuration server 210 provides a web based interface to notify the subscriber 105 of any delay while retrieving information from the OSS 120B or in completing a requested CCS configuration. In a further example, the configuration server 210 provides a web based interface to notify the subscriber 105 that a CCS configuration cannot be completed because of access restrictions on either service account. In yet another example, if the OSS 120B does not respond to the configuration server 210 (e.g., due to unavailability or processing load), the configuration server 210 could provide a web based display instructing the subscriber to re-request the CCS configuration again at a later time.

It will also be readily apparent to persons of ordinary skill in the art that configuration of other types of CCS could be implemented using messages exchanges similar to the examples illustrated in FIGS. 3, 4 and 5. For example, the user 105 and the configuration server 210 could interact to configure a CCS that forwards a call placed to phone number (e.g., wireless, VoIP, land line, etc.) provided by the system 110B with a telephone number (e.g., wireless, VoIP, land line, etc.) provided by the system 110A. In another example, the user 105 and the configuration server 210 could interact to configure a CCS that forwards caller identification (i.e., caller ID) information provided by the system 110B to a communication service provided by the system 110A. In yet another example, a CCS could be configured by the user 105 and the configuration server 210 to forward a call placed to a telephone number provided by the system 110B to a facsimile service provided by the system 110A.

It will be readily apparent to persons of ordinary skill in the art that a subscriber could configure a CCS using other well-known interface techniques. For example, the configuration server 210 could be implemented using a voice interaction system (VIS), the interface device 205 could be implemented using a telephony device (e.g., a wireless telephone, a land line telephone, a VoIP telephone, etc.), and the connection 210 could be implemented using a telephony connection (e.g., wireless, land land, or VoIP). In particular, computer generated or recorded messages provided by the configuration server 210 could be played to prompt the user 105 to enter necessary information, the user 105 could enter information by pressing or selecting keys on a telephone keypad (provided by the interface device 205), and the VIS (i.e., configuration server 210) could receive the information by decoding the Dual Tone Multi-Frequency (DTMF) signals initiated by each key press or selection.

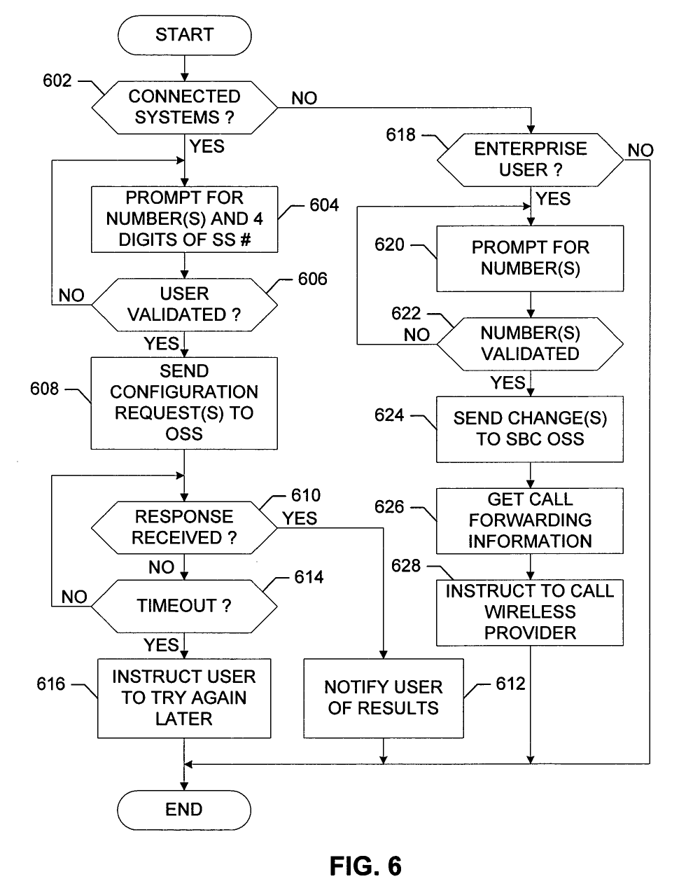

FIG. 6 illustrates a flowchart representative of example machine readable instructions that may be executed by a processor (e.g., the processor 710 of FIG. 7) to implement the example configuration server 210 of FIG. 2. The machine readable instructions of FIG. 6 and/or the example configuration server 210 may be executed by a processor, a controller and/or any other suitable processing device. For example, the machine readable instructions of FIG. 6 and/or the example configuration server 210 may be embodied in coded instructions stored on a tangible medium such as a flash memory, or random access memory (RAM) associated with the processor 710 shown in the example processor platform 700 and discussed below in conjunction with FIG. 7. Alternatively, some or all of the example machine readable instructions of FIG. 6 and/or the example configuration server 210 may be implemented using an application specific integrated circuit (ASIC), a programmable logic device (PLD), a field programmable logic device (FPLD), discrete logic, hardware, software, and/or firmware. Also, some or all of the machine readable instructions of FIG. 6 and/or the example configuration server 210 may be implemented manually or as combinations of any of the foregoing techniques. Further, although the example machine readable instructions of FIG. 6 are described with reference to the flowchart of FIG. 6, persons of ordinary skill in the art will readily appreciate that many other methods of implementing the example configuration server 210 of FIG. 2 may be employed. For example, the order of execution of the blocks may be changed, and/or some of the blocks described may be changed, eliminated, or combined.

The example machine readable instructions of FIG. 6 begin when the user 105 initiates a CCS configuration via a user interface provided by the configuration server 210. The configuration server 210 determines if the user 105 who is a subscriber of the system 110A also is a subscriber to services provided by another system (e.g., the system 110B) to which the system 110A can communicate via, for example, the paths 130 and 135 and the bridge 140 (block 602). If the systems are connected and cooperative (block 602), the configuration server 210 prompts for telephone number(s) and the password associated with the telephone number(s) (block 604). For example, if the user 105 initiates a configuration to add an association, or a remove an association, between a telephone number and a voicemail account, the configuration server 210 prompts for a telephone number. In another example, the user 105 initiates a change in the telephone number associated to a voicemail account, the configuration server 210 prompts for two telephone numbers and their associated passwords (e.g., last four digits of SS number(s) or business tax ID number(s)).

The configuration server 210 then validates the password received from the user 105 with the password received from the system 110B (block 606). If the passwords to not match, the configuration server 210 returns to block 604 to re-prompt the user 105 for corrected information. For example, the configuration server 210 could re-prompt for only the password associated to a telephone number. Additionally, the configuration server 210 could attempt to validate the password twice before terminating the example machine readable instructions of FIG. 6.

Returning to block 606, if the passwords match, the configuration server 210 sends a CCS configuration request to OSS 120A (block 608). The configuration server 210 then determines if a response has been received from the OSS 120A (block 610). If a response is not received (block 610), the configuration server 210 determines if a pre-determined amount of time has passed (block 614). If the pre-determined amount of time has not passed (block 614), the configuration server 210 returns to block 610 to determine if a response has been received from the OSS 120A. If a pre-determined amount of time has passed (block 614), i.e., a timeout, the configuration server 210 notifies the user 105 to re-attempt the CCS configuration at a later time (block 616). The configuration server 210 then ends the example machine readable instructions of FIG. 6.

Returning to block 610, if a response has been received, the configuration server 210 notifies the user 105 of the results of the CCS configuration request (block 612). For example, the configuration server 210 could notify the user 105 that the configuration was successful, was not successful, etc. The configuration server 210 then ends the example machine readable instructions of FIG. 6.

Returning to block 602, if the systems are not connected, the configuration server 210 determines if the user 105 is allowed to configure a CCS between the two systems (e.g., an SBC enterprise customer) (block 618). If the user is allowed to configure a CCS between the two systems (block 618), the configuration server 210 prompts the user 105 for a telephone number(s) (block 620). The configuration server 210 determines if the telephone number(s) provide by the user 105 are valid telephone numbers (block 622). If the numbers are not valid, the configuration server 210 re-prompts the user to re-enter valid telephone numbers (block 620). The configuration server 210 could only re-prompt the user 105 once before terminating the example machine readable instructions of FIG. 6.

Returning to block 622, if the provided telephone number(s) are valid, the configuration server 210 sends a CCS configuration request to the OSS 120A (block 624). The configuration server 210 receives CCS configuration information (e.g., a telephone forwarding during for a voicemail account) (block 626). The configuration server 210 then provides the CCS configuration information to the user 105 and provides information that the user 105 needs to configure the other system to complete the CCS configuration, perhaps by contacting a customer service representative of the system 110B (block 628). The configuration server 210 then ends the example machine readable instructions of FIG. 6.

It will also be readily apparent to persons of ordinary skill in the art that example machine readable instructions illustrated in FIG. 6 could be modified to configure other types of CCSs. For example, the configuration server 210 could configure a CCS that forwards a call placed to phone number (e.g., wireless, VoIP, land line, etc.) provided by the system 110B with a telephone number (e.g., wireless, VoIP, land line, etc.) provided by the system 110A. In another example, the configuration server 210 configures a CCS that forwards caller identification (i.e., caller ID) information provided by the system 110B to a communication service provided by the system 110A. In yet another example, a CCS configured by the configuration server 210 forwards a call placed to a telephone number provided by the system 110B to a facsimile service provided by the system 110A.

FIG. 7 is a schematic diagram of an example processor platform 700 capable of executing the example machine readable instructions of FIG. 6 to implement the configuration server 210 of FIG. 2. For example, the processor platform 700 can be implemented by one or more general purpose microprocessors, microcontrollers, etc.

The processor platform 700 of the example of FIG. 7 includes a general purpose programmable processor 710. The processor 710 executes coded instructions present in main memory of the processor 710 (e.g., a RAM 725). The processor 710 may be any type of processing unit, such as a microprocessor from the Intel®, AMD®, or SUN® families of microprocessors. The processor 710 may implement, among other things, the configuration server 210 of FIG. 2 by, for example, executing the machine readable instructions of FIG. 6.

The processor 710 is in communication with the main memory (including a read only memory (ROM) 720 and the RAM 725) via a bus 705. The RAM 725 may be implemented by Synchronous Dynamic Random Access Memory (SDRAM), Dynamic DRAM, and/or any other type of RAM device. The ROM 720 may be implemented by flash memory and/or any other desired type of memory device. Access to the memory 720 and 725 is typically controlled by a memory controller (not shown) in a conventional manner.

The processor platform 700 also includes a conventional interface circuit 730. The interface circuit 730 may be implemented by any type of well known interface standard, such as an external memory interface, serial port, general purpose input/output, etc.

One or more input devices 735 and one or more output devices 740 are connected to the interface circuit 730. The input devices 735 and output devices 740 may be used to implement interfaces between the configuration server 210 and the system 110A, the OSS 120A, the Internet 215, and/or the interface device 205.

Of course, persons of ordinary skill in the art will recognize that the order, size, and proportions of the memory illustrated in the example systems may vary. Additionally, although this patent discloses example systems including, among other components, software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, persons of ordinary skill in the art will readily appreciate that the above described examples are not the only way to implement such systems.

At least some of the above described example methods and/or apparatus are implemented by one or more software and/or firmware programs running on a computer processor. However, dedicated hardware implementations including, but not limited to, application specific integrated circuits, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular standards and protocols, it sis understood that the teachings of the invention are not limited to such standards and protocols. For instance, each of the standards for Internet and other packet switched network transmission (e.g., Transmission Control Protocol (TCP)/IP, User Datagram Protocol (UDP)/IP, HyperText Markup Language (HTML), HyperText Transfer Protocol (HTTP)) represent examples of the current state of the art. Such standards are periodically superseded by faster or more efficient equivalents having the same general functionality. Accordingly, replacement standards and protocols having the same functions are equivalents which are contemplated by the teachings of the invention are intended to be included within the scope of the accompanying claims.

The teachings of the invention contemplate one or more machine readable mediums containing instructions, or receiving and executing instructions from a propagated signal so that, for example, a device connected to a network environment can send or receive voice, video or data, and communicate over the network using the instructions. Such a device can be implemented by any electronic device that provides voice, video or data communication, such as a telephone, a cordless telephone, a mobile phone, a cellular telephone, a Personal Digital Assistant (PDA), a set-top box, a computer, and/or a server.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A system comprising:
a first communication system to provide a first communication service to a communication service subscriber;
a second communication system to provide a second communication service to the subscriber, wherein the first and second communication systems are configurable to exchange communication service data;
a configuration server to provide a user interface to receive a configuration request from the subscriber, and to configure the first and the second communication services to execute a cooperative communication service based on the received configuration request.

2. A system as defined in claim 1, wherein the configuration server is a web based display server or a voice interaction system.

3. A system as defined in claim 1, wherein executing the cooperative communication service uses at least one resource from each of the first and the second communication systems.

4. A system as defined in claim 1, wherein:
the first communication service is a Unified Communications service;
the second communication service is a telephony service; and
the cooperative communication service associates the Unified Communications service with the telephony service.

5. A system as define in claim 4, wherein the telephony service is a wireless telephony service, a land line telephony service, a Voice over Internet Protocol (VoIP) telephony service.

6. A system as defined in claim 1, wherein:
the first communication service is a telephony service, a voicemail service, a facsimile service, a caller ID service, or a call forwarding service;
the second communication service is a telephony service, a voicemail service, a facsimile service, a caller ID service, or a call forwarding service; and
the cooperative communication service associates the first and the second communication services.

7. A system as defined in claim 6, wherein a telephony service may be a wireless telephony service, a land line telephony service, or a Voice over Internet Protocol (IP) (VoIP) telephony service.

8. A system as defined in claim 1, wherein the first and the second communication systems exchange communication service data using one or more of an Internet Protocol (IP) based network, an Asynchronous Transfer Mode (ATM) based network, a Frame Relay based network, a public switched telephone network (PSTN), and/or a telephony network.

9. A system as defined in claim 1, wherein the configuration server automatically configures the first and the second communication services to execute a cooperative communication service based on the received configuration request.

10. A system as defined in claim 1, wherein the configuration server configures the second communication service to execute a cooperative communication service based on the received configuration request by supplying via the user interface information necessary to allow the customer to configure the second communication service.

11. A system as defined in claim 1, wherein the configuration server interacts with the second communication system indirectly through the first communication system.

12. A system as defined in claim 1, further comprising a communication bridge between the first and the second communications systems to translate at least a portion of configuration communications between the first and the second communication systems.

13. A system as defined in claim 1, wherein the configuration server is configured to validate the received configuration request using information obtained from the second communication system.

14. An article of manufacture storing machine readable instructions which, when executed, cause a machine to:
receive a configuration request and identifying information from a customer via an Internet based user interface;
validate the received identifying information using information obtained from a first communication system providing a first communication service to the customer; and
respond to the received configuration request to configure the first communication service and a second communication service provided to the customer by a second communication system to implement a converged communication service.

15. An article of manufacture as defined in claim 14, wherein the first communication service is a telephony service;
the second communication service is a Unified Communications service; and
the converged communication service associates the Unified Communications service with the telephony service.

16. An article of manufacture as defined in claim 15, wherein the telephony service is a wireless telephony service or a Voice over Internet Protocol (VoIP) telephony service.

17. An article of manufacture as defined in claim 14, wherein:
the first communication service is a telephony service, a voicemail service, a facsimile service, a caller ID service, or a call forwarding service;
the second communication service is a telephony service, a voicemail service, a facsimile service, a caller ID service, or a call forwarding service; and
the cooperative communication service associates the first and the second communication services.

18. An article of manufacture as defined in claim 17, wherein a telephony service may be a wireless telephony service, a land line telephony service, or a Voice over Internet Protocol (IP) (VoIP) telephony service.

19. An article of manufacture as defined in claim 14, wherein the machine readable instructions, when executed, cause the machine to respond to the received configuration request to configure the second communication service to implement a converged communication service by supplying to the customer information necessary to allow the customer to configure the first communication service.

20. A method to configure a first communication system providing a first communication service to a user, and a second communication system providing a second communication service to the user comprising:
receiving an electronic configuration request from the user for a combined communication service;
automatically validating the electronic configuration request based on information obtained from the second communication system via the first communication system; and
if the electronic configuration request is valid, automatically configuring the first and/or the second communication services to implement the combined communication service.

21. A method as defined in claim 20, wherein
the first communication service is a Unified Communications service;
the second communication service is a telephony service; and
the combined communication service associates the Unified Communications service with the telephony service.

22. A method as defined in claim 20, wherein:
the first communication service is a telephony service, a voicemail service, a facsimile service, a caller ID service, or a call forwarding service;
the second communication service is a telephony service, a voicemail service, a facsimile service, a caller ID service, or a call forwarding service; and
the cooperative communication service associates the first and the second communication services.

23. A method as defined in claim 22, wherein a telephony service may be a wireless telephony service, a land line telephony service, or a Voice over Internet Protocol (IP) (VoIP) telephony service.

24. A method as defined in claim 20, further comprising providing to the user information necessary to allow the user to configure the second communication service.

25. A system comprising:
a first communication system to provide a Unified Communications service to a communication service subscriber;
a second communication system to provide a telephony service to the subscriber;
a communications path between the first and the second communication systems to exchange communication service data;
a configuration server to provide a user interface to receive a service configuration from the subscriber, and to configure the first and the second communication systems to deliver a service associating the Unified Communications service with the telephony service using at least one resource from each of the first and the second communication systems.

26. A system as defined in claim 25, wherein the configuration server is a web based display server or a voice interaction system.

27. A system as defined in claim 25, wherein the telephony service is a wireless telephone service.

28. A system as defined in claim 25, wherein the telephony service is a Voice over Internet Protocol (VOIP) service.
